(19) United States
(12) Patent Application Publication
(10) Pub. No.: US 2008/0030089 A1
(43) Pub. Date: Feb. 7, 2008

(54) Air Bearing Spindles

(76) Inventor: Robin John William Powell, Dorset (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/572,354

(22) PCT Filed: Jul. 21, 2005
(86) PCT No.: PCT/GB05/02865

§ 371 Date: Jan. 19, 2007

(30) Foreign Application Priority Data
Jul. 23, 2004 (GB) 0416495.0

(51) Int. Cl. H02K 7/08

(52) U.S. Cl. 310/67 R

(57) ABSTRACT

An air bearing spindle comprising a shaft journalled, by virtue of an air bearing, for rotation within a sleeve and a motor for driving the shaft relative to the sleeve, wherein the motor comprises stator windings and the shaft defines a generally annular accommodating recess in which the stator windings are disposed so that, in use, a peripheral portion of the shaft provides part of a magnetic flux path associated with the stator windings and wherein the spindle comprises an axial air bearing.

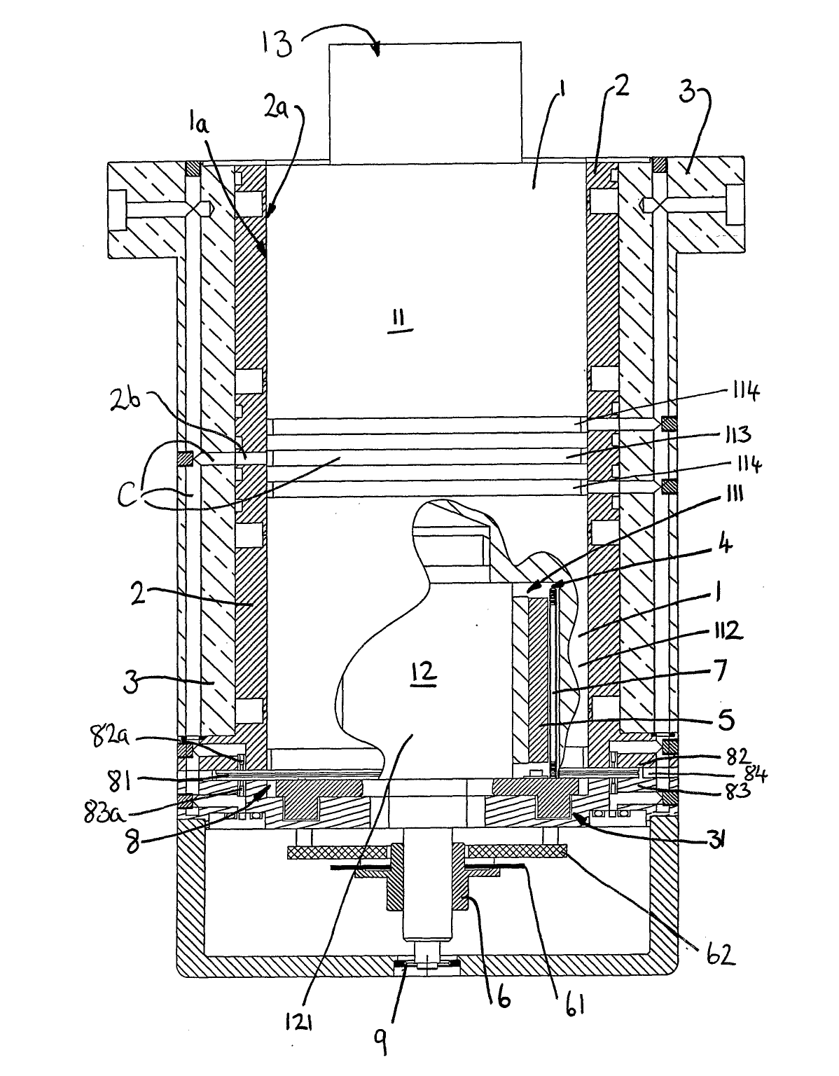

This invention relates to air bearing spindles. The invention is particularly suited for use in relatively low speed applications (say 10,000 rpm to 15,000 rpm). One application which is of particular interest is that of disk test spindles, other possible applications include use in the semiconductor and machine tool industries.

A common existing technique for driving air bearing spindles is to form a motor by mounting permanent magnets on the shaft and providing driving windings in the stationary part of the spindle. The shaft typically is journalled in one or more air bearing provided in the spindle and the magnets and windings are located between or to one side of the bearings. In applications where there is a single air bearing this arrangement means that the shaft and bearing act as a cantilever supporting the motor. This influences how compact the spindle can be and can compromise the dynamic performance of the spindle.

These arrangements make use of conventional brushless DC motor ideas and thus can suffer from hysteresis losses and cogging effects.

Recently developed brushless DC electric motors with ironless stators have made available motion systems with very smooth motion. This is due to the rotor carrying both the permanent magnets and a ring of magnetic material to provide a return path to complete the magnetic circuit so that there is no relative motion between these components. In the simplest form, such a motor comprises three elements, wound stator coils, permanent magnets and return iron. These last two have been typically combined as one component, to be attached to the shaft that the motor is to drive. Typically these motors make use of hydrodynamic (oil-based) bearings or ball bearings between the rotor and stator.

Some applications of air bearing spindles are becoming ever more demanding in terms of quality of motion. The disturbances caused by the irregular flux coupling found within traditional electric motors are now of significant concern. The ironless stator type of motor potentially offers great improvements in motion quality but their implementation has been hindered by the large mass, polar inertia and diameter of the motor rotors that these systems have demanded. These factors have to date negated the potential advantages.

It is an object of the present invention to alleviate at least some of the problems associated with the prior art.

According to one aspect of the present invention there is provided an air bearing spindle comprising a shaft journalled, by virtue of an air bearing, for rotation within a sleeve and a motor for driving the shaft relative to the sleeve, wherein the motor comprises stator windings and the shaft defines a generally annular accommodating recess in which the stator windings are disposed so that, in use, a peripheral portion of the shaft provides part of a magnetic flux path associated with the stator windings.

This has advantages in that a compact design can be achieved and the number of components used can be minimised. Furthermore use of material of the shaft itself is made to provide a flux return path.

Typically, the shaft has a bearing surface facing a corresponding bearing surface provided in the sleeve. Preferably the stator windings accommodating recess is disposed radially inwards of the shaft bearing surface. Consequentially, the stator windings may be disposed radially inwards of the shaft bearing surface. In at least some such cases not only is it material of the shaft that provides the return path, but it is material that needs to be present to provide the bearing surface.

The sleeve may comprise a main bore within which the shaft is carried. The outer diameter of the stator windings accommodating recess may be smaller than the diameter of the main bore of the sleeve.

The air bearing spindle may be an aerostatic air bearing spindle. The air bearing spindle may comprise an axial air bearing. This axial air bearing can act as a thrust bearing.

The stator windings may be generally annular and the diameter of the stator windings may be smaller than the diameter of the main bore of the sleeve.

In this specification the expression generally annular is used to refer to any generally ring-like structure which need not have a geometrically perfect annular shape. Particularly in the case of the stator windings, there may be individual components arranged together to give an overall shape that is generally annular.

The configuration features defined above can tend to lead to a compact design and can give rise to the possibility of the motor being disposed within the air bearing.

The air bearing can be considered to have an axial length which corresponds to the region of the shaft that is directly supported by the air bearing. Preferably the stator windings accommodating recess is provided at least partly within the portion of the shaft that is within the axial length of the air bearing during operation. This configuration can give rise to a compact design and can be used to avoid the need to have the motor cantilevered beyond the bearings.

Typically the stator windings are ironless windings and the peripheral portion of the shaft acts as backing iron for the ironless windings. It will be understood that windings often comprise coils of wire wound around a magnetic material core (often iron) and that ironless windings comprises at least one coil of wire but no magnetic material core. Particularly where ironless windings are used, there can be performance advantages in embodiments of the present invention compared to systems making use of conventional DC motor arrangements. This is at least partly because hysteresis losses and cogging effects can be reduced or removed.

The stator windings accommodating recess may be provided in one end of the shaft and the stator windings may protrude axially from the sleeve into the recess. The stator windings may be arranged as a hollow cylinder which protrudes axially from a base portion of the sleeve.

The shaft may comprise a stem portion carrying at least one permanent magnet which is part of the motor and may further comprise a peripheral skirt portion disposed around the stem. The stator winding accommodating recess may be defined between the stem and the skirt.

The shaft may have a main shaft portion that is a single piece of material, the main shaft portion including the skirt. The stem portion may be of a piece of material distinct from the main shaft portion.

The shaft of the spindle may carry an encoder assembly for use in control and/or monitoring driving of the shaft.

The spindle may comprise a contact portion for electrically grounding the shaft. The contact portion may comprise a seal disposed around a portion of the shaft. The seal may be mounted on the sleeve of the spindle. The seal may comprise a magnetic fluid seal, so that the only contact between the sleeve and shaft is via a fluid.

According to another aspect of the present invention there is provided a shaft for use in an air bearing spindle of the type defined above, the shaft comprising a stem portion carrying at least one permanent magnet and a peripheral skirt portion disposed around the stem, there being a stator windings accommodating recess defined between the stem and the skirt portion.

The air spindle may be a disk test air bearing spindle. The air bearing spindle may comprise an auxiliary port for providing an air path connection to a chuck receiving portion. The auxiliary port may be a vacuum port. This allows the chuck to be held in place under action of a vacuum. This may be achieved directly or indirectly. The chuck may have a taper portion which is received and held in a corresponding taper under action of the vacuum. Alternatively the chuck receiving portion may comprise a mechanism operable under action of a vacuum to grip the chuck. Similarly the auxiliary port may be fed with a positive pressure supply of air to operate a mechanism to grip the chuck. The mechanism for gripping a chuck may comprise a spring pack and/or a piston.

Embodiments of the present invention will now be described by way of example only with reference to the accompanying drawing which shows a disk test air bearing spindle.

The drawing shows a disk test air bearing spindle incorporating an ironless DC motor for rotatingly driving a shaft 1 of the spindle. Such a disk test spindle is used for carrying and rotating media disks during testing operations prior to the media disks being assembled into a disk drive unit. The disks are carried by a hub (not shown) that is mounted on the shaft 1.

Whilst the present invention is useful in disk test spindles, as mentioned above, the present invention is more broadly applicable than this.

The shaft 1 of the spindle is journalled in an air bearing 2 which in turn is disposed in a spindle housing 3. The housing 3 and bearing 2 can together be considered to provide a sleeve in which the shaft 1 is journalled for rotation. The bearing has an internal generally cylindrical bearing surface 2a which faces a corresponding outer cylindrical bearing surface 1a of the shaft 1.

The air bearing 2 is an aerostatic bearing and is provided with jets and supply channels to feed air to the space between the bearing surfaces 1a, 2a to allow the bearing to operate. These jets and channels are not shown in detail or described in detail as these aspects of the spindle are generally conventional and make use of well known technology in the air bearing field.

The shaft 1 comprises two main components—a main shaft portion 11, the outer surface of which comprises the shaft bearing surface 1a and a tail assembly 12 which is threadingly mounted to the main shaft portion 11. The tail assembly 12 is disposed in a bore 111 provided in the end of the main portion of the shaft 11 opposite to the end which carries the hub (not shown).

A main part of the bore 111 is defined by what can be termed a skirt portion 112 of the main portion of the shaft 11. The outer surface of this skirt portion forms part of the shaft bearing surface 1a and the inner surface of the skirt portion 112 together with the tail assembly 12 defines a generally annular recess 4 in the end of the shaft 1.

The tail assembly 12 of the shaft comprises a set of permanent magnets 5 mounted on a stem portion 121. The magnets 5 form part of the motor used for driving the shaft 1 relative to the housing 3. The outer surfaces of the magnets 5 partly define the inner boundary of the generally annular recess 4.

The tail assembly 12 is carries an encoder assembly 6 which is generally conventional and can be used to control/monitor driving of the shaft 1. The encoder assembly 6 comprises an encoder disc 61 which is arranged to rotate with the shaft 1. An encoder printed circuit board and encoder detector 62 are mounted on the housing 3. The encoder assembly 6 and printed circuit board and detector 62 together form an encoder arrangement for use in controlling/monitoring driving of the shaft.

A tube-like or hollow cylinder shaped set of ironless stator windings 7 are mounted on the spindle housing 3 so as to project axially from a base portion 31 of the spindle housing 3 and be received in the generally annular recess 4. The stator windings 7 are thus disposed in the vicinity of the set of magnets 5 and moreover the skirt portion 112 of the shaft surrounds the stator windings 7. At least the skirt portion 112 of the shaft is of magnetic material, typically magnetic steel, and thus this can act as a flux return path for the windings 7.

The shaft 1 is electrically connected to the housing 3 via a contact portion, which in this embodiment comprises a magnetic fluid seal 9. This contact portion serves to ground the shaft 1 with a view to preventing undesirable electrical effects affecting carried discs. Such magnetic fluid seals 9 are commercially available and contact with the shaft 1 is via magnetic fluid, the seal in this case being mounted to the housing 3.

Together, the magnets 5, windings 7 (with appropriate driving current sources and control unit which are not shown) and skirt portion 112 as “back iron” provide an effective motor for driving the shaft 1 relative to the housing 3. This ironless stator DC motor gives the smooth performance associated with such motors and use of the material of the shaft as the back iron alleviates some of the problems which have been found in previous spindles using such motors.

It will also be noted that the diameter of the stator windings 7 and the annular recess 4 is smaller than the diameter of the bearing surface la of the shaft. Thus the motor may be provided “within” the air bearing 2 in the radial sense. Furthermore, the generally annular recess 4, magnets 5, skirt portion 112 and stator windings 7 are each disposed entirely or substantially entirely within the axial length of the air bearing 2. Thus the motor 5, 7, 112 can be said to be disposed within the air bearing 2 in the axial sense and is not supported by the shaft 1 and bearing 2 acting as a cantilever. This improves dynamics and compactness of the spindle.

The use of a part of the shaft 1 that acts as part of the bearing surface 1a to provide the backing iron for the motor saves on components and reduces the mass and moment of inertia of the driven components compared to systems which use a discrete dedicated component for backing iron.

The spindle comprises an axial (thrust) air bearing 8 in addition to the radial air bearing 2. The thrust bearing comprises an axial thrust runner 81 provided on the shaft 1 which is disposed between a pair of thrust plates 82,83 provided in the housing. The thrust plates 82,83 are separated by a thrust spacer 84 and comprise respective jets 82a,82b for supplying air to the thrust bearing.

The spindle comprises channels C for allowing a vacuum pump (not shown) to be operatively connected to a chuck receiving portion 13 of the shaft 1 so that when a chuck for holding disks (not shown) is received by the receiving portion 13 it can be held in place at least partially under action of a vacuum. The air bearing 2 comprises a vacuum port 2b which provides an air connection path to a vacuum supply groove 113 provided in the cylindrical surface 1a of the shaft 1. An aperture (not shown) leads from this groove 113 to a central bore (not shown) of the shaft 1, which in turn leads to the chuck receiving portion 13. In this embodiment the chuck receiving portion has an internal taper into which a taper portion of a chuck may be received. The central bore leads to this internal taper so that suction may be applied by a vacuum pump to a taper portion of a carried chuck.

A pair of exhaust grooves 114 are provided in the cylindrical surface 1a of the shaft 1, one on each side of the vacuum supply groove 113. These exhaust grooves 114 receive and exhaust to atmosphere air from respective portions of the radial air bearing 2 on either side of the vacuum supply groove 113 and help to ensure effective operation of the vacuum system.

1. An air bearing spindle comprising a shaft journalled, by virtue of an aerostatic air bearing, for rotation within a sleeve and a motor for driving the shaft relative to the sleeve, wherein the motor comprises stator windings and the shaft defines a generally annular accommodating recess in which the stator windings are disposed so that, in use, a peripheral portion of the shaft provides part of a magnetic flux path associated with the stator windings and wherein the spindle comprises an axial aerostatic air bearing.

2. A spindle according to claim 1 comprising a contact portion for electrically grounding the shaft.

3. A spindle according to claim 2 wherein the contact portion comprises a magnetic fluid seal.

4. A spindle according to claim 1 wherein the shaft has a bearing surface facing a corresponding bearing surface provided in the sleeve and the stator windings accommodating recess is disposed radially inwards of the shaft bearing surface.

5. A spindle according to claim 1 wherein the air bearing comprises an auxiliary port.

6. A spindle according to claim 5 wherein the auxiliary port is for providing an air path connection to a chuck receiving portion.

7. A spindle according to claim 6 wherein a chuck received in the receiving portion is gripped under one of direct and indirect action of air being one of provided to and extracted via the auxiliary port.

8. A spindle according to any claim 5 in which the auxiliary port is a vacuum port.

9. A spindle according to claim 4 wherein the stator windings are disposed radially inwards of the shaft bearing surface.

10. A spindle according to claim 1 wherein the sleeve comprises a main bore within which the shaft is carried and the outer diameter of the stator windings accommodating recess is smaller than the diameter of the main bore of the sleeve.

11. A spindle according to claim 10 wherein the stator windings are generally annular and the diameter of the stator windings is smaller than the diameter of the main bore of the sleeve.

12. A spindle according to claim 1 wherein the air bearing has an axial length which corresponds to the region of the shaft that is directly supported by the air bearing and the stator windings accommodating recess is provided at least partly within the portion of the shaft that is within the axial length of the air bearing during operation.

13. A spindle according to claim 1 wherein the stator windings are ironless windings and the peripheral portion of the shaft acts as backing iron for the ironless windings.

14. A spindle according to claim 1 wherein the stator windings accommodating recess is provided in one end of the shaft and the stator windings protrude axially from the sleeve into the recess.

15. A spindle according to claim 1 wherein the stator windings are arranged as a hollow cylinder which protrudes axially from a base portion of the sleeve.

16. A spindle according to claim 1 wherein the shaft comprises a stem portion carrying at least one permanent magnet which is part of the motor and further comprises a peripheral skirt portion disposed around the stem portion, and wherein the stator winding accommodating recess is defined between the stem portion and the skirt.

17. A spindle according to claim 16 wherein the shaft has a main shaft portion that is a single piece of material, the main shaft portion including the skirt.

18. A spindle according to claim 1 wherein the spindle is a disk test air bearing spindle.

19. A spindle according to claim 1 further comprising an encoder arrangement for use in at least one of controlling and monitoring driving of the shaft.

20. A shaft for use in an air bearing spindle according to claim 1, the shaft comprising a stem portion carrying at least one permanent magnet and a peripheral skirt portion disposed around the stem portion, there being a stator windings accommodating recess defined between the stem portion and the skirt portion.
